(19) United States
(12) Patent Application Publication
(10) Pub. No.: US 2025/0216592 A1
(43) Pub. Date: Jul. 3, 2025

(54) IMMERSED POLARIZERS FOR OPTICAL STRUCTURES

(71) Applicant: Apple Inc., Cupertino, CA (US)

(72) Inventor: Mark A Arbore, Los Altos, CA (US)

(21) Appl. No.: 18/983,778

(22) Filed: Dec. 17, 2024

Related U.S. Application Data
(60) Provisional application No. 63/616,092, filed on Dec. 29, 2023.

(51) Int. Cl. G02B 5/30

(52) U.S. Cl. CPC G02B 5/3058

(57) ABSTRACT

Optical structures including a polarizer are disclosed. The polarizer is positioned between and in contact with other layers of the optical structure. The polarizer defines an effective refractive index for the polarization aligned with the polarization axis and may be configured to help reduce reflection losses within the optical structure for this polarization.

### CROSS-REFERENCE TO RELATED APPLICATIONS

This application is a nonprovisional and claims the benefit under 35 U.S.C. 119(e) of U.S. Provisional Patent Application No. 63/616,092, filed Dec. 29, 2023, the contents of which are incorporated herein by reference as if fully disclosed herein.

### FIELD

The described embodiments relate generally to optical structures that include a polarizer. More particularly, the present embodiments relate to a multilayer optical structure that includes a polarizer that is positioned between other layers of the optical structure, where the polarizer is indexed matched with another portion of the optical structure.

### BACKGROUND

Optical systems are used to transmit light for any of a variety of purposes. Some optical systems use a conventional polarizer in order to preferentially transmit light having a specific polarization to an optical component of the optical system. It is desirable to configure a polarizer to minimize optical losses and/or etalons of light having the specific polarization as it traverses the polarizer.

### SUMMARY

The present disclosure relates to optical structures that include a polarizer. In aspects of the present disclosure, the polarizer is positioned between other layers of the optical structure. For example, a first layer of the optical structure may include the polarizer, a second layer of the optical structure may contact the input surface of the polarizer, and a third layer of the optical structure may contact the output surface of the polarizer. The polarizers described herein may be incorporated into any suitable optical structure that is capable of transmitting light in a target wavelength range.

The polarizer may be configured as a wire grid polarizer that includes a plurality of metal wires that are generally aligned to define an array and a dielectric filler positioned between adjacent metal wires of the array. When the pitch of the wires is sufficiently small as compared to the wavelength of incoming light, the polarizer may behave as if has a homogenous refractive index. Accordingly, although the metal wires and the dielectric filler have different refractive indices, the polarizer will have an effective refractive index that is based on a combination of the two. For the purpose of discussion, the effective refractive index of a polarizer refers to the composite refractive index experienced by light having the polarization that is preferentially transmitted by the polarizer.

The polarizer preferentially transmits light having a first polarization (also referred to herein as the “transmitted polarization”) while blocking light having other polarizations (also referred to herein as the “blocked polarizations”). The transmitted polarization is aligned with the polarization axis of the polarizer. The optical structure may be configured to reduce or minimize loss of light having the transmitted polarization. In some embodiments, the optical structure may be configured to reduce undesirable reflection of light having the transmitted polarization at interfaces between layers of the optical structure. In some cases, the effective refractive index of the polarizer may be matched to the refractive indices of adjoining layers of the optical structure. In additional cases, the optical structure may be configured to provide “step-down” transitions of the refractive index at the interfaces between layers of the optical structure. For example, a first layer including the polarizer may define an effective refractive index for the polarization aligned with the polarization axis, a second layer defining the input surface of the optical structure may have a refractive index that is greater than the effective refractive index, and a third layer defining the output surface of the optical structure may have a refractive index that is less than the effective refractive index. Furthermore, the polarizer may be configured to minimize absorption and reflection of light having the polarization aligned with the polarization axis.

The disclosure provides an optical structure comprising a first layer comprising a polarizer that defines an input surface and an output surface, the polarizer comprising an array of metal nanowires that defines a polarization axis and a dielectric filler having a first refractive index and positioned between adjacent metal nanowires of the array of metal nanowires, the polarizer having an effective refractive index for a light polarization aligned with the polarization axis, a second layer having a second refractive index that matches the effective refractive index, the second layer contacting the input surface of the polarizer, and a third layer having a third refractive index and contacting the output surface of the polarizer.

The disclosure also provide an optical structure comprising a first layer including a polarizer defining a polarization axis and an effective refractive index for a polarization aligned with the polarization axis, the polarizer comprising a plurality of wires formed from a metal material and defining a sub-wavelength pitch between adjacent wires of the plurality of wires and a dielectric material positioned between adjacent metal wires of the plurality of wires and having a first refractive index, a second layer contacting an input surface of the polarizer and having a second refractive index that matches the effective refractive index, and a third layer contacting an output surface of the polarizer and having a third refractive index that matches the effective refractive index.

The disclosure further provides an optical structure comprising a first layer including a first portion comprising a polarizer defining a polarization axis and an effective refractive index for a polarization aligned with the polarization axis, the polarizer comprising an array of metal nanowires and a dielectric filler positioned between adjacent metal nanowires of the array of metal nanowires, the dielectric filler having a first refractive index, a second portion coplanar with the first portion and having a refractive index that is matched to the effective refractive index; a second light transmissive layer contacting an input surface of the polarizer, and a third light transmissive layer contacting an output surface of the polarizer.

### BRIEF DESCRIPTION OF THE DRAWINGS

The disclosure will be readily understood by the following detailed description in conjunction with the accompanying drawings, wherein like reference numerals designate like elements.

FIG. 1 shows a partial cross-sectional view of an optical structure.

FIG. 2 shows another partial cross-sectional view of an optical structure.

FIG. 3 shows another partial cross-sectional view of an optical structure.

FIG. 4 shows another partial cross-sectional view of an optical structure.

FIG. 5 shows another partial cross-sectional view of an optical structure.

FIG. 6 shows another view of an optical structure.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

The present disclosure relates to optical structures that include a polarizer. In aspects of the present disclosure, the polarizer is positioned between other layers of the optical structure. The polarizer may be immersed in the optical structure. For example, the polarizer may be included in a first layer of the optical structure, a second layer of the optical structure may contact the input surface of the polarizer, and a third layer of the optical structure may contact the output surface of the polarizer.

The polarizer may be configured as a wire grid polarizer that includes a plurality of metal wires. The metal wires may be generally aligned to define an array having a pitch. The polarizer further comprises a dielectric filler positioned between adjacent metal wires of the array. As previously discussed, the polarizer may define an effective refractive index for the polarization aligned with the polarization axis of the polarizer (“the transmitted polarization”). For a wire grid polarizer, the polarization axis may be perpendicular to the longitudinal axis of the wires.

The polarizer may be indexed matched with one or more other portions of the optical structure. In embodiments, the effective refractive index for the transmitted polarization may be matched with the refractive index of another portion of the optical structure. In some examples, the effective refractive index of the polarizer may be matched to the refractive indices of adjoining layers of the optical structure. Alternately or additionally, the polarizer may define a first portion of a layer of the optical structure (e.g., the first layer) and a refractive index of a second portion of the layer may be matched to the effective refractive index. For example, a first layer having this configuration may be positioned between second and third layers that are index matched to the first layer. As another example, a first layer having this configuration may be positioned between a second layer having a higher refractive index and a third layer having a lower refractive index, thereby providing refractive index transitions through the thickness of the optical structure.

The polarizers described herein may be incorporated into any suitable optical structure that is capable of transmitting light. For example, in some variations, the optical structure may be configured as a lens or prism, such that the polarizer may polarize at least a portion of light passing through the lens or prism. In other variations, the optical structure may be a photodetector, such that at least a portion of the light measured by the photodetector is polarized by the polarizer. In still other variations, the optical structure may be a light source, such that polarizer polarizes at least a portion of the light generated by the light source. In embodiments where the polarizer defines one or more portions of a layer of the optical structure, these portions may be patterned according to the requirements of the optical structure. In some cases, the optical structure may be optically coupled to another optical component of an optical system.

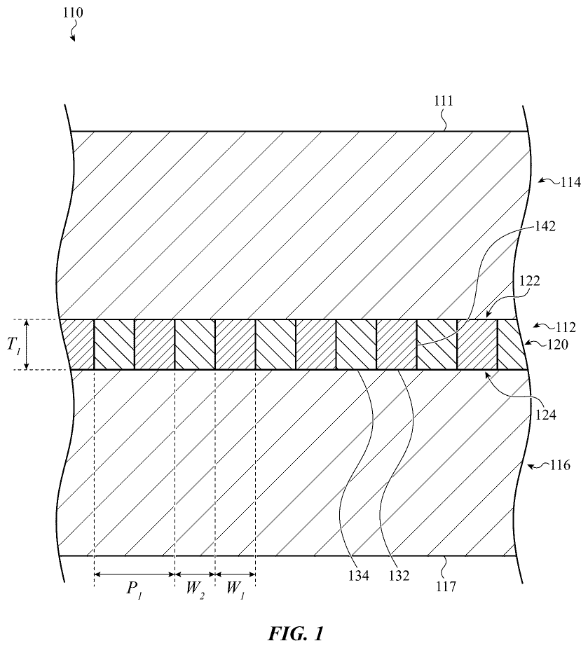

These and other embodiments are discussed below with reference to FIGS. 1-6. However, those skilled in the art will readily appreciate that the detailed description given herein with respect to these figures is for explanatory purposes only and should not be construed as limiting.

FIG. 1 shows a partial cross-sectional view of an optical structure. The optical structure 110 includes a first layer 112 that comprises a polarizer 120. The polarizer 120 is immersed in the optical structure 110 such that a second layer 114 contacts an input surface 122 of the polarizer 120 and a third layer 116 contacts an output surface 124 of the polarizer 120. The optical structure 110 defines an input surface 111 and an output surface 117.

In embodiments, the polarizer 120 includes a plurality of metal wires 132. The metal wires 132 may be generally aligned to define an array, which may form a wire grid polarizer. For example, the metal wires 132 may be generally parallel with respect to one another. The polarizers described herein are designed to operate across a target range of wavelengths. The metal wires 132 may each have a width, W₁, that is less than each wavelength of the target range of wavelengths and may alternately be referred to as sub-wavelength metal wires. For example, the width W₁ may be less than or equal to a tenth of each wavelength of the target range of wavelengths. In some cases, the metal wires may be referred to as metal nanowires (e.g., having a width less than 1 micrometer). In some examples, each of the metal wires has a width, W₁, that is greater than or equal to 1 nm and less than 400 nm, such a width from 5 nm to 300 nm, from 5 nm to 200 nm, from 5 nm to 100 nm, or from 5 nm to 50 nm. While it may be desirable for each metal wire to have the same width, it should be appreciated that manufacturing processes may result in slight width variations from a target width, either along the length of a given wire or between different wires.

The array of metal wires may be periodically arranged along the input surface 122. A pitch, P₁, between respective side surfaces 142 of adjacent metal wires 132 of the array may be less than the wavelength(s) of light incident on the input surface 122 of the polarizer, so that the pitch P₁ is a sub-wavelength pitch. The pitch P₁ may alternately be referred to as the period of the array. While it may be desirable for the pitch to be the same across the array, it should be appreciated that manufacturing processes may result in slight pitch variations from a target pitch, either along the length of a pair of adjacent wires or between different pairs of adjacent wires. When the pitch, P₁, is sub-wavelength the polarizer 120 may preferentially transmit light that has a polarization aligned with a polarization axis of the polarizer, as discussed below. It should be appreciated that, in some instances, the pitch P₁ may be intentionally varied across one or more portions of the polarizer 120 if so desired.

The metal wires 132 may have a length that is greater than their width. For example, the length of each of the metal wires 132 may be at least 10 times greater than the width W₁ (the longitudinal axis of the metal wires 132 is perpendicular to the cross-sectional plane of FIG. 1). The length of the wires may be largely determined by the size of the polarizer in that dimension. The polarization axis of the polarizer 120 may be perpendicular to the longitudinal axis of the metal wires. The metal wires 132 may have a thickness T₁ that is greater than a skin depth of the metal material from which wires are formed. As an example, the thickness may range from 75 nm to 400 nm or from 100 nm to 300 nm. Examples of metal materials suitable for forming the metal wires 132 include, but are not limited to, aluminum, copper, chromium, tungsten, gold, silver, a compound including or more of these metals (e.g., titanium nitride, tantalum nitride, or the like), an alloy including one or more of these metals, or the like.

In the example of FIG. 1, the side surface 142 of the metal wire 132 is perpendicular to both the input surface 122 and the output surface 124 of the polarizer 120. Depending on the manufacturing technique used to create the polarizer 120, it should be appreciated that the metal wires 132 may have side surfaces that have a slight angle with respect to the input surface and/or the output surface of the polarizer. While it may be desirable for each side surface to have the same angle with respect to the input surface and/or the output surface, it should be appreciated that manufacturing processes may result in slight width variations from a target angle (e.g., a target angle of ninety degrees with respect to the input surface and the output surface).

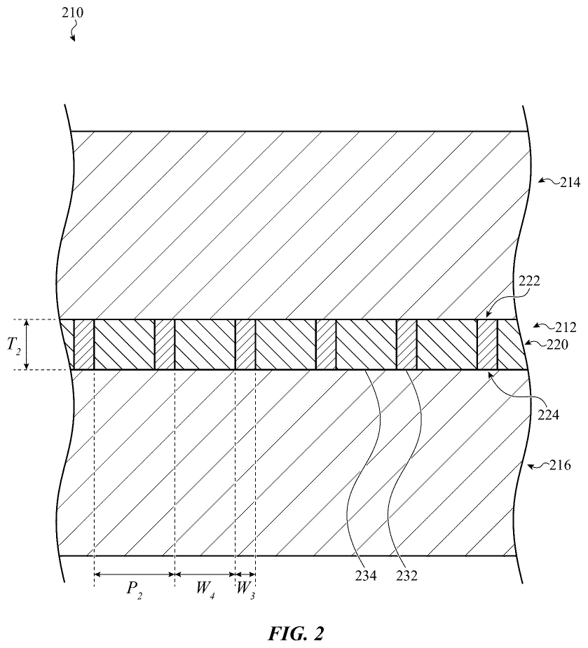

In the example of FIG. 1, the polarizer 120 further comprises a filler 134. As shown in FIG. 1, at least some of the filler 134 is positioned between adjacent metal wires of the array of metal wires 132 and has a width W₂. The width, W₂, may be less than the wavelength(s) of light incident on the input surface 122 and therefore the filler may alternately be referred to as a sub-wavelength filler. While it may be desirable for each filler to have the same width, it should be appreciated that manufacturing processes may result in slight width variations from a target filler width. In an example, the filler 134 also has a same thickness TI, as the metal wires 132. The metal wires 132 and the filler 134 are substantially coplanar. The filler 134 and/or the metal wire 132 may define a lateral edge of the polarizer. In some cases, the ratio W₁/W₂, which may alternately be referred to as the duty cycle, may be used to characterize the polarizer. The duty cycle of the polarizer may vary to allow index matching of the polarizer with another portion of the optical structure. In some examples, the ratio may be based on a ratio of target or average values for the widths of the metal wires and segments of filler, respectively, across the polarizer. In other examples, such as when the side surface 142 is not perpendicular to the input surface 122, the duty cycle may be based on a ratio of the average volume of a metal wire divided by the average volume of the filler. In the example of FIG. 1, the duty ratio is about 0.5. However, this example is not limiting, as shown in the example of FIG. 2. In some embodiments, the ratio duty ratio is greater than or equal to 0.2 and less than 0.5. In some embodiments, the filler 134 is formed from a dielectric material. Suitable dielectric materials for the filler 134, include, but are not limited to a silicon oxide (e.g., SiO₂) or a silicon nitride (e.g., Si₃N₄). The real part of refractive index of a given dielectric material is used for purposes of comparison herein. The complex part of the refractive index of a given dielectric material may be non-existent or very small.

As previously mentioned, the polarizer 120 may preferentially transmit light that has a polarization that is aligned with the polarization axis. The transmittance of light having a polarization aligned with the polarization axis divided by the transmittance of light having a polarization that is perpendicular to the polarization axis may be used as one measure of the performance of the polarizer 120. This ratio, alternately referred to as the extinction coefficient, may vary with wavelength. In some embodiments the transmittances of these light polarizations may be calculated, for example by using a rigorous wave coupled analysis (RWCA) simulation. As examples, the extinction coefficient may be greater than or equal to 10 dB, greater than or equal to 15 dB, or greater than or equal to 20 dB for a specified angle/angles of incidence and a target range of wavelengths.

The polarizer 120 may be birefringent. For example, the refractive index for a light polarization that is aligned with the polarization axis may be different than the refractive index for a light polarization that is perpendicular to the polarization axis. When the metal wires 132 and the filler 134 have sub-wavelength dimensions, the polarizer 120 may be characterized by effective indices of refraction (e.g., for the “transmitted polarization” aligned with the polarization axis and for a polarization perpendicular to the polarization axis). The effective index of refraction may be complex indices of refraction that include both real and complex parts.

For the purpose of the following discussion, the effective refractive index of a polarizer refers to the composite refractive index experienced by light having the polarization that is preferentially transmitted by the polarizer. The effective refractive index depends on the indices of refraction of the metal wires 132 and the filler 134, as well as the duty ratio. Although the effective refractive index for the polarization aligned with the polarization axis may have a complex part as well as a real part, the polarizer 120 may be designed so that the real part of the effective index of reflection is dominant for this polarization. In this case, the effective refractive index of the polarizer can be compared to the refractive index of another layer or a portion of another layer by comparing the real portions of the refractive indices. In some examples, the real part of the effective refractive index for the polarization aligned with the polarization axis is greater than the refractive index of the filler 134.

In some embodiments, the polarizer 120 may be configured so that reflection of light at the input surface 122 is minimized for light that has a polarization aligned with the polarization axis. For example, the polarizer 120 may be configured so that effective refractive index for a light polarization aligned with the polarization axis is matched to a refractive index of the second layer 114. In some cases, the effective refractive index of the polarizer can be viewed as matched with another layer or a portion of another layer when the real part of the effective refractive index for this polarization is matched to the real part of the refractive index of the other layer to within a specified tolerance. In some examples where the effective refractive index for this polarization is matched to another layer, a magnitude of the difference between the real part of the effective refractive index and the real part of the refractive index for the other layer, such as the second layer 114, is less than or equal to 0.5, less than or equal to 0.4, less than or equal to 0.3, or less than or equal to 0.2. In some embodiments the percentage of light having a polarization aligned with the polarization axis that is reflected at the input surface 122 can be calculated, such as via a RWCA simulation. By the way of example, the percentage of light having a polarization aligned with the polarization axis that is reflected at the input surface 122 may be less than 5%, less than or equal to 3%, less than or equal to 2%, less than or equal to 1%, less than or equal to 0.5%, or less than or equal to 0.25% for a specified angle/angles of incidence and a target range of wavelengths.

The second layer 114 is typically transmissive for light over a target range of wavelengths and may be referred to as a light transmissive layer. In some embodiments the target range of wavelengths is an infrared wavelength range, a visible wavelength range, or any other desired wavelength range. In some cases, the second layer is formed from a semiconductor material, such a group IV semiconductor (e.g., silicon) or a III-V semiconductor (e.g., indium phosphide, InP) that has a bandgap suitable for use with the target range of wavelengths. Although the refractive index for a semiconductor material may generally have a complex part as well as a real part, the complex part of the refractive index may be small in the target range of wavelengths. Therefore, the real part of the refractive index of a layer formed of a semiconductor material may be used to compare the refractive index of this layer to another layer in the optical structure. The real part of the refractive index of the second layer 114 may be greater than a refractive index of the filler 134. As an example, when the second layer 114 is formed from silicon, the filler 134 may be formed from a silicon nitride (e.g., Si₃N₄) or a silicon oxide (e.g., SiO₂).

In other cases, the second layer 114 may be formed from a dielectric material. Examples of suitable dielectric materials include, but are not limited to, a silicon oxide (e.g., SiO₂), a silicate glass, a silicon nitride (Si₃N₄), or an aluminum oxide (e.g., Al₂O₃). In some embodiments, the filler 134 is formed from a first dielectric material that has a first refractive index that is less than a second refractive index of the second dielectric material of the second layer 114. As an example, when the second layer 114, is formed from a silicon nitride, the filler may be formed from a silicon oxide (e.g., SiO₂). As previously mentioned, the second layer 114 contacts the polarizer 120. In some embodiments the contact between the second layer 114 and the polarizer 120 substantially eliminates any gaps between the second layer 114 and the polarizer 120.

The third layer 116 is typically transmissive for light over a target range of wavelengths and may be referred to as a light transmissive layer. In the example of FIG. 1, the second layer 114 and the third layer 116 have a same thickness. However, this example is not limiting and in other examples these layers need not have the same thickness. In the example of FIG. 1, the third layer 116 may be formed of a same material as the second layer 114. In some embodiments where the third layer 116 is formed from the same material as the second layer 114, the refractive indices of each of the third layer 116 and the second layer 114 may be matched with the effective refractive index of the polarizer of the first layer 112. As previously discussed, reflection at interfaces between the first and second layers and the first and third layers may be minimized in these embodiments.

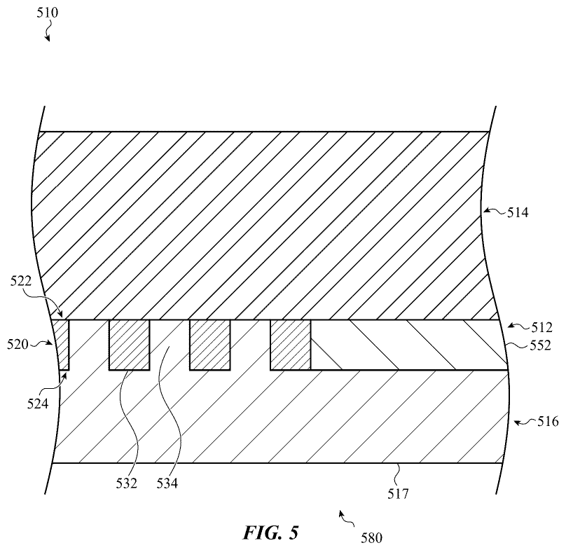

However, the example of FIG. 1 is not intended to be limiting and in some embodiments, the third layer 116 may be formed from a different material from the second layer 114. For example, the optical structure 110 may be configured so that the second layer 114 has the highest refractive index, the third layer 116 has the lowest refractive index, and the polarizer 120 is configured to provide an effective refractive index that is intermediate between the second refractive index and the third refractive index. FIG. 5 shows an example of this configuration and the additional description provided with respect to FIG. 5 is generally applicable herein.

FIG. 2 shows another partial cross-sectional view of an optical structure. The optical structure 210 includes a first layer 212 that comprises a polarizer 220. The optical structure 210 also includes a second layer 214 that contacts an input surface 222 of the polarizer 220 and a third layer 216 that contacts an output surface 224 of the polarizer 220.

As previously discussed, the duty cycle of the polarizer may vary in order to allow index matching of the polarizer with another portion in the optical structure. In contrast to the optical structure 110 shown in FIG. 1, the optical structure 210 shows a duty cycle in which the metal wires 232 have a width W₃ that is less than the width W₄ of the filler 234. Therefore, the contribution of the filler 234 to the effective refractive index of the polarizer 220 for the light polarization aligned with the polarization axis may be greater than in the example of FIG. 1. The pitch P₂ and the thickness T₂ may be similar to the pitch P₁ and the thickness T₁ or may be different. The materials, refractive indices, and the other dimensions of the metal wires 232 and the filler 234 may be similar to the materials, refractive indices, and other dimensions of the metal wires 132 and the filler 134. The second layer 214 and the third layer 216 may be similar to the second layer 114 and the third layer 116 in terms of materials, refractive indices, and other properties.

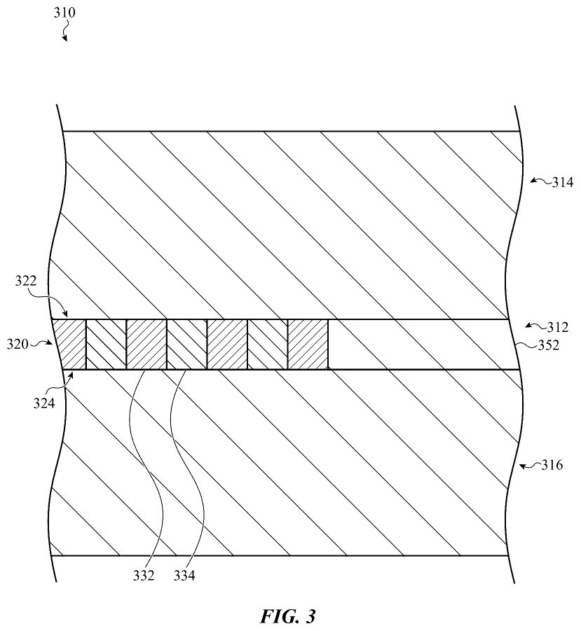

FIG. 3 shows another partial cross-sectional view of an optical structure. In the example of FIG. 3, the first layer 312 of the optical structure 310 includes a polarizer 320 and also includes an additional portion 352 that is coplanar with the polarizer 320. The polarizer 320 may alternately be described as defining a first portion of the first layer 312 and the additional portion 352 as defining a second portion of the first layer 312. The first layer 312 is positioned between a second layer 314 and a third layer 316. In some embodiments, the second layer 314 and the third layer 316 are formed of a same material.

In some embodiments, the second portion 352 of the first layer 312 may be formed of a same material as the second layer 314 and the third layer 316. Therefore, the refractive index of the second portion 352 may be matched to the refractive indices of the second layer 314 and the third layer 316. When the effective refractive index of the polarizer 320 for the polarization aligned with the polarization axis is matched with the refractive index of the second layer 314, the refractive index of the second portion 352 may also be matched to the effective refractive index of the polarizer 320. This configuration allows for minimization of reflection at the interfaces between the first layer 312 and the second layer 314, as well as the first layer 312 and the third layer 316. The refractive index of the filler 334 may be referred to as a first refractive index, the refractive index of the second layer 314 may be referred to as a second refractive index, the refractive index of the third layer 316 may be referred to as a third refractive index, and the refractive index of the second portion 352 may be referred to as a fourth refractive index. As previously discussed, these refractive indices may be characterized by the real parts of the refractive index for purposes of comparison.

In some embodiments, each of the second layer 314, the third layer 316, and the second portion 352 is formed of a same semiconductor material. For example, each of the second layer 314, the third layer 316, and the second portion 352 may be formed from silicon, which may be crystalline silicon. In this example, the filler 334 may be formed from a silicon nitride, a silicon oxide, or any other suitable dielectric material. In some cases, the second portion 352 may be integrally formed with either the second layer 314 or the third layer 316.

In some embodiments, each of the second layer 314, the third layer 316, and the second portion 352 is formed of a same dielectric material. For example, each of the second layer 314, the third layer 316, and the second portion 352 may be formed from a silicon nitride. In this example, the filler 334 may be formed from a silicon oxide or any other suitable dielectric material. As previously described, the second portion 352 may be integrally formed with either the second layer 314 or the third layer 316.

As shown in FIG. 3, the second layer 314 contacts an input surface 322 of the polarizer 320 and the second portion 352 and the third layer 316 contacts an output surface 324 of the polarizer 320 and the second portion 352. The polarizer 320, the second layer 314, and the third layer 316 may be similar in many respects to the polarizer 120, the second layer 114, and the third layer 116. For example, the second layer 314 and the third layer 316 may be similar to the second layer 114 and the third layer 116 in terms of materials, refractive indices, and other properties. The materials, refractive indices, and the other dimensions of the metal wires 332 and the filler 334 may be similar to the materials, refractive indices, and dimensions described with respect to the metal wires 132 and the filler 134.

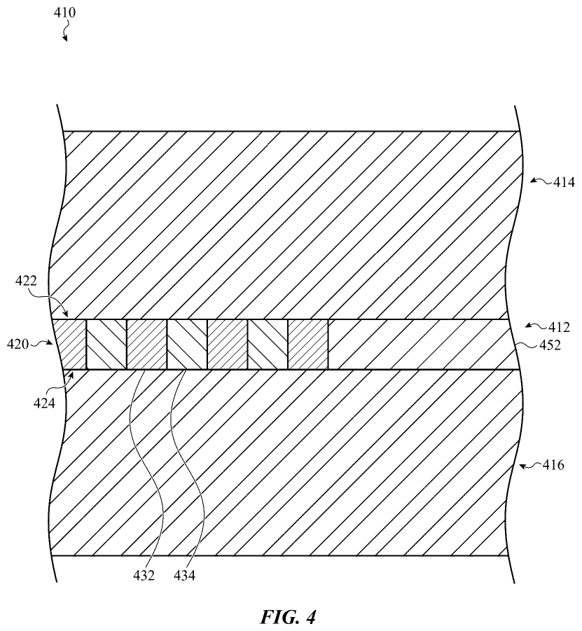

FIG. 4 shows another partial cross-sectional view of an optical structure. In the example of FIG. 4, the first layer 412 of the optical structure 410 includes a polarizer 420 and also includes an additional portion 452 that is coplanar with the polarizer 420. The polarizer 420 may alternately be described as defining a first portion of the first layer 412 and the additional portion 452 as defining a second portion of the first layer 412. The first layer 412 is positioned between a second layer 414 and a third layer 416. In some embodiments, the second layer 414 and the third layer 416 are formed of a same material.

In embodiments in which the second layer 414 and the third layer 416 are formed of a same material, the second portion 452 of the first layer 412 may be formed of another material that has a property that is similar to the same property of the material of the second and third layers. For example, the second portion 452 of the first layer 412 may have a refractive index that is matched to the refractive indices of the second layer 414 and the third layer 416. A chemical composition of the second portion 452 may also be similar to that of each of the second layer 414 and the third layer 416. When the effective refractive index of the polarizer 420 for the polarization aligned with the polarization axis is matched with the refractive index of the first layer 412, the refractive index of the second portion 452 may also be matched to the effective refractive index of the polarizer 420. This configuration allows for reduction of reflection at the interfaces between the first layer 412 and each of the second layer 414 and the third layer 414.

In some embodiments, each of the second layer 414 and the third layer 416, and the second portion 452 is formed from a semiconductor material. For example, each of the second layer 414 and the third layer 416 may be formed from a crystalline silicon material and the second portion 452 may be formed from an amorphous silicon material. In this example, the filler 434 may be formed from a silicon nitride, a silicon oxide, or any other suitable dielectric material.

As shown in FIG. 4, the second layer 414 contacts an input surface 422 of the polarizer 420 and the second portion 452 and the third layer 416 contacts an output surface 424 of the polarizer 420 and the second portion 452. The polarizer 420, the second layer 414, and the third layer 416 may be similar in many respects to the polarizer 120, the second layer 114, and the third layer 116. For example, the second layer 414 and the third layer 416 may be similar to the second layer 114 and the third layer 116 in terms of materials, refractive indices, and other properties. The materials, refractive indices, and the other dimensions of the metal wires 432 and the filler 434 may be similar to the materials, refractive indices, and dimensions described with respect to the metal wires 132 and the filler 134.

FIG. 5 shows another partial cross-sectional view of an optical structure. In the example of FIG. 5, the first layer 512 of the optical structure 510 includes a polarizer 520 and also includes an additional portion 552 that is coplanar with the polarizer 520. The polarizer 520 may alternately be described as defining a first portion of the first layer 512 and the additional portion 552 as defining a second portion of the first layer 512. The first layer 512 is positioned between a second layer 514 and a third layer 516. The third layer 516 defines an output surface 517 of the optical structure 510. In some embodiments, each of the second layer 514, the second portion 552 of the first layer 512, and the third layer 516 is formed of a different material.

In some embodiments, the optical structure 510 is configured so that different layers of the optical structure have different refractive indices. In some examples, the second layer 514 has the highest refractive index, the third layer 516 has the lowest refractive index, and the polarizer 520 is configured to provide an effective refractive index that is intermediate between the second refractive index and the third refractive index. The second portion 552 of the first layer 512 may have a refractive index that is matched to this effective refractive index of the polarizer 520. The first layer 512 and the third layer 516 may therefore provide a stepped refractive index transition between the second layer 514 and an environment 580. In some cases, the environment 580 may be an air environment.

In some embodiments, the second layer 514 may be formed of a semiconductor material, the third layer 516 may be formed from a dielectric material, and the second portion 552 of the first layer 512 may be formed from a different dielectric material than the third layer 516. As shown in FIG. 5, the filler 534 is formed of a same dielectric material as the third layer 516 and may be integrally formed with the third layer 516. For example, the second layer 514 may be formed from silicon, the third layer 516 and the filler 534 may be formed from a silicon oxide, and the second portion of the first layer 512 may be formed of a silicon nitride. In some cases, a thickness of the third layer 516 may be one quarter of a wavelength within the target range of wavelengths.

As shown in FIG. 5, the second layer 514 contacts an input surface 522 of the polarizer 520 and the second portion 552 and the third layer 516 contacts an output surface 524 of the polarizer 520 and the second portion 552. The polarizer 520, the second layer 514, and the third layer 516 may be similar in many respects to the polarizer 120, the second layer 114, and the third layer 116. For example, the second layer 414 and the third layer 416 may be similar to the second layer 114 and the third layer 116 in terms of materials, refractive indices, and other properties. The materials, refractive indices, and the other dimensions of the metal wires 532 and the filler 534 may be similar to the materials, refractive indices, and dimensions described with respect to the metal wires 132 and the filler 134.

In some embodiments, the optical structures described herein may define, may include, or may be included in a light transmissive optical component, a light receiving device, or light emitting device. Examples of light-transmissive optical components include, but are not limited to, waveguides, lenses, mirrors, prisms, and diffractive optical elements. Examples of light receiving devices include, but are not limited to, photodetectors and solar cells. Examples of light emitting devices include, but are not limited to, lasers and micro-LEDs.

In some embodiments, the second and/or third layers of the optical structures described herein may define an exterior surface of the optical structure. For example, in instances where the optical structure is a lens, the second layer may form a first external surface of the lens and the third layer may form a second external surface of the lens. In other instances, the optical structure may include one or more additional materials in contact with the second and/or third layers and one or more of these additional materials may define an external surface of the optical structure. For example, in instances where the optical structure includes a photodetector, additional layers of the photodetector (e.g., various semiconductor layers, metal contacts, etc.) may be in contact one or more both of the second and/or third layers.

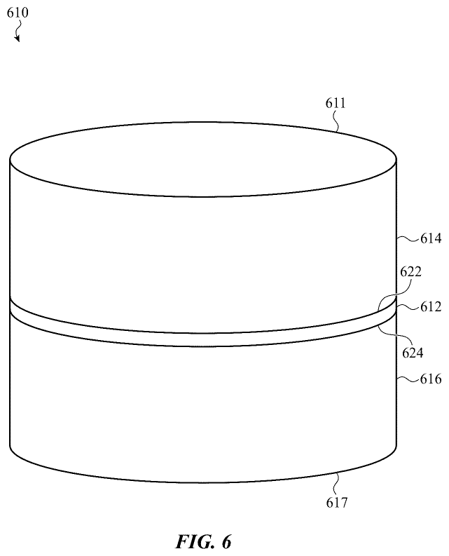

FIG. 6 shows another view of an optical structure as described herein. In the example of FIG. 6, the optical structure 610 includes a first layer 612 that includes a polarizer. The polarizer of the first layer 612 is immersed in the optical structure 610 such that a second layer 614 of the optical structure 610 contacts an input surface 622 of the polarizer and a third layer 616 of the optical structure 610 contacts an output surface 624 of the polarizer. In the example of FIG. 6, the second layer 614 defines an input surface 611 of the optical structure 610 and the third layer 616 defines an output surface 617 of the optical structure 610. The optical structure 610 may be any of the optical structures described herein, including the optical structures described with respect to FIGS. 1-5.

The relative thicknesses of the first, second, and third layers shown in FIG. 6 are not intended to be limiting and in other examples the first layer may have a greater relative thickness as previously shown in the examples of FIGS. 1-5. The first layer 612 may be similar to any of the layers 112, 212, 312, 412, or 512, the second layer 614 may be similar to any of the layers 114, 214, 314, 414, or 514, and the third layer 616 may be similar to any of the layers 116, 216, 316, 416, or 516.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An optical structure comprising:
a first layer comprising a polarizer that defines an input surface and an output surface, the polarizer comprising:
an array of metal nanowires that defines a polarization axis; and
a dielectric filler having a first refractive index and positioned between adjacent metal nanowires of the array of metal nanowires, the polarizer having an effective refractive index for a light polarization aligned with the polarization axis;
a second layer having a second refractive index that matches the effective refractive index, the second layer contacting the input surface of the polarizer; and
a third layer having a third refractive index and contacting the output surface of the polarizer.

2. The optical structure of claim 1, wherein:
the second layer is formed from a semiconductor material;
the second refractive index is greater than the first refractive index; and
the third layer is formed from the semiconductor material and the third refractive index is the same as the second refractive index.

3. The optical structure of claim 2, wherein:
an additional portion of the first layer is formed from the semiconductor material; and
the additional portion of the first layer is coplanar with the polarizer.

4. The optical structure of claim 2, wherein:
each of the second layer and the third layer is formed from crystalline silicon; and
an additional portion of the first layer is formed from amorphous silicon.

5. The optical structure of claim 1, wherein:
the dielectric filler is formed from a first dielectric material;
the second layer is formed from a second dielectric material;
the second refractive index is greater than the first refractive index; and
the third layer is formed from the second dielectric material.

6. The optical structure of claim 5, wherein:
an additional portion of the first layer is formed from the second dielectric material; and
the additional portion of the first layer is coplanar with the polarizer.

7. The optical structure of claim 1, wherein a duty ratio of the metal nanowires in the polarizer is greater than or equal to 0.2 and less than 0.5.

8. An optical structure comprising:
a first layer including:
a polarizer defining a polarization axis and an effective refractive index for a polarization aligned with the polarization axis, the polarizer comprising:
a plurality of wires formed from a metal material and defining a sub-wavelength pitch between adjacent wires of the plurality of wires; and
a dielectric material positioned between adjacent metal wires of the plurality of wires and having a first refractive index;
a second layer contacting an input surface of the polarizer and having a second refractive index that matches the effective refractive index; and
a third layer contacting an output surface of the polarizer and having a third refractive index that matches the effective refractive index.

9. The optical structure of claim 8, wherein:
the polarizer defines a first portion of the first layer; and
the first layer further defines a second portion formed from a material having a fourth refractive index matched to the effective refractive index.

10. The optical structure of claim 9, wherein the material having the fourth refractive index is different from each of the metal material and the dielectric material.

11. The optical structure of claim 10, wherein:
each of the second portion of the first layer, the second layer, and the third layer is formed from a silicon nitride; and
the dielectric material is a silicon oxide.

12. The optical structure of claim 10, wherein:
each of the second portion of the first layer, the second layer, and the third layer is formed from silicon; and
the dielectric material is a silicon nitride.

13. The optical structure of claim 8, wherein the metal material is aluminum, copper, chromium, or tungsten.

14. An optical structure comprising:
a first layer including:
a first portion comprising a polarizer defining a polarization axis and an effective refractive index for a polarization aligned with the polarization axis, the polarizer comprising:
an array of metal nanowires; and
a dielectric filler positioned between adjacent metal nanowires of the array of metal nanowires, the dielectric filler having a first refractive index;
a second portion coplanar with the first portion and having a refractive index that is matched to the effective refractive index;
a second light transmissive layer contacting an input surface of the polarizer; and
a third light transmissive layer contacting an output surface of the polarizer.

15. The optical structure of claim 14, wherein:
the first refractive index is less than the effective refractive index;
the second light transmissive layer has a second refractive index that is greater than the effective refractive index;
the third light transmissive layer has a third refractive index that is less than the effective refractive index; and
the refractive index of the second portion of the first layer is a fourth refractive index.

16. The optical structure of claim 15, wherein:
the dielectric filler is formed from a silicon oxide; and
the second portion of the first layer is formed from a silicon nitride.

17. The optical structure of claim 16, wherein:
the second light transmissive layer is formed from silicon; and
the third light transmissive layer is formed from the silicon oxide.

18. The optical structure of claim 17, wherein the third light transmissive layer is integrally formed with the dielectric filler.

19. The optical structure of claim 17, wherein:
the third light transmissive layer defines an output surface of the optical structure; and
the output surface of the optical structure is in contact with air.

20. The optical structure of claim 14, wherein:
the first refractive index that is less than the effective refractive index;
the second light transmissive layer has a second refractive index that matches the effective refractive index;
the third light transmissive layer has a third refractive index that matches the effective refractive index; and
the refractive index of the second portion of the first layer is a fourth refractive index.
